(19) United States
(12) Patent Application Publication
(10) Pub. No.: US 2011/0252647 A1
(43) Pub. Date: Oct. 20, 2011

(54) DEVICE FOR CUTTING FRUIT, VEGETABLES OR THE LIKE

(75) Inventor: Kit Kwan PAU, KOWLOON (HK)

(73) Assignee: WINGS PRODUCT WORKSHOP LIMTED, KOWLOON (HK)

(21) Appl. No.: 13/089,263

(22) Filed: Apr. 18, 2011

(30) Foreign Application Priority Data
Apr. 19, 2010 (CN) 201020162981.7

(51) Int. Cl. A47J 25/00; A47J 43/28; B26B 27/00

(52) U.S. Cl. 30/124; 30/296.1; 30/302

(57) ABSTRACT

A device for cutting fruit, vegetables or the like includes at least one cutting member (1), a cap (2) and a base (3). The cutting member includes a casing (12) combining blades (10) therein. The cap is configured to releasably cover on the cutting member via a connection means (5), and is adapted for one-hand operation. The base has an upper concave surface (30) for retaining fruit, vegetables, or the like inside, and can support the cutting member thereon. The device is easily operated to cut fruit, vegetables or the like by one hand, and can prevent juice irritating or overflowing around during cutting operation.

### BACKGROUND OF THE INVENTION

The present invention relates to a cutting device for food, and especially to a device for cutting fruit, vegetables, or the like.

In everyday life, there is a considerable need for cutting fruit or vegetables into slices or segments, such as cutting apple, orange, watermelon, into segments. Various cutting devices are available now for fast cutting operation. A traditional fruit and vegetables cutter includes a cutting frame combining a plurality of blades therein, and a pair of handles symmetrically set on two sides of the cutting frame. In cutting operation, fruit or vegetables to be cut is placed on a work surface, the frame is pressed towards the work surface with two-hand operation, and then the blades cut the fruit or vegetables into segments. However, it is inconvenient for the user to operate the cutter using two hands at the same time. Moreover, the blades have been integrated into the frame, and cannot be replaced, so that the numbers of the blades or the shape thereof cannot be changed, which sometimes is not suitable for cutting different material.

Chinese Pat. No. ZL200480041783.2 disclosed a device for cutting fruit or vegetables including a cutter element and a counterpart, which are pivotably enjoined via a pivot connection on the side of the counterpart. In use, fruit and vegetables to be cut is placed on the counterpart element, the cutting element is pressed downward onto the counterpart, whereupon the blades cut the fruit or vegetables into pieces. This cutting device can be operated by one hand. However, the structure thereof is relatively complicated, which results in high cost for manufacturing as well. A further disadvantage is that the juice from fruit or vegetables during cutting operation will irritate around or overflow to stain chopping block or work surface.

Therefore, an improved device for cutting fruit, vegetables or the like is desired which overcomes the disadvantages of the prior art.

### BRIEF SUMMARY OF THE INVENTION

A main object of the present invention is to provide a simpler device for cutting fruit, vegetables, or the like, which can be easily operated only with one hand to cut fruit or the like, and can prevent juice irritating or overflowing around during cutting operation.

To obtain the above object, a device for cutting fruit, vegetables or the like in the present invention comprises at least one cutting member, a cap, and a base for supporting the cutting member thereon. The cutting member has a casing combining blades therein. The cap can be releasably fitted on the cutting member via a connection means, and is adapted for one-hand cutting operation. The base has an upper concave surface for retaining fruit, vegetables, or the like therein.

The connection means between the cap and the cutting member comprises a bayonet mount, a screw closure, a detent connection, or clamping means. Preferably, the clamping means comprises at least one stick set on the cap, and at least one aperture correspondingly defined in the cutting member. Preferably, the clamp means comprises two or more pairs of sticks respecitvly engaged in corresponding apertures. It is understood that the position of the stick and the aperture can be interchanged each other. In an exemplary embodiment, the casing of the cutting member is substantially cylindrical, and forms an annular flange at bottom edge thereof. The annular flange is coaxial with the casing. A plurality of clamps longitudinally extend upward or downward from the flange and each clamp with the annular flange defining one aperture therebetween. Furthermore, a plurality of raised points can be set on the surface around the aperture, so that the stick can be locked therein, but can be released out under a certain force.

Each blade has one end thereof joining at a point on a central axis in the casing, and with the other end thereof radially extends from the point to inner wall of the casing. Preferably, the other ends of blades are embedded in the inner wall of the casing.

In the preferable embodiment, the base substantially has a vertical main body with the upper concave surface on top thereof, and a circular bottom container for receiving juice. The main body defines a plurality of slots which correspond to the blades of the cutting member and into which the blades dip when the cutting member is resting on the base. A plurality of projections are set on the concave surface for engaging the fruit, vegetables or the like member to prevent slippage thereof while contained in the base.

The cutting member can move to rest on the base via a guiding means in a linear movement. The guiding means comprises leading ledge, leading post, or the like engaged in guiding groove or guiding wall.

The cap releasably covers on the cutting member, which is suitable for one-hand operation, and prevents juice irritating. The structure is very simple and in turn easily manufactured.

The base firmly holds a fruit or vegetables in position and permits steady cutting on the concave surface thereof. A plurality of projections is preferably set on the concave surface for engaging the fruit member to prevent slippage thereof while contained in the base. The bottom circular container is adapted to receive the fruit juice, which prevents fruit overflowing to stain the work surface or the like.

The guiding means assures a linear and steady movement of the cutting member on the base, together with the slots in the base for receiving blades therein, by which the device can steadily cut fruit member to segments in good appearance. Furthermore, sets of cutting members with different numbers of or different shapes of the blades, are suitable for any cutting need or any kind of material to be cut.

Other objects, advantages and novel features of the invention will become more apparent from the following detailed description of a preferred embodiment thereof when taken in conjunction with the accompanying drawings, wherein:

### BRIEF DESCRIPTION OF THE DRAWINGS

FIG. 1 is an exploded, perspective view of a device for cutting fruit, vegetables or the like in accordance with an embodiment of the present invention;

FIG. 2 is a partially exploded, section view of the device for cutting fruit, vegetables or the like of the present invention;

FIG. 3 is a section view of the device for cutting fruit, vegetables or the like in FIG. 1 after assembled together; and

FIG. 4 is a perspective view of blades for cutting fruit, vegetables or the like in FIG. 1.

### DETAILED DESCRIPTION OF THE INVENTION

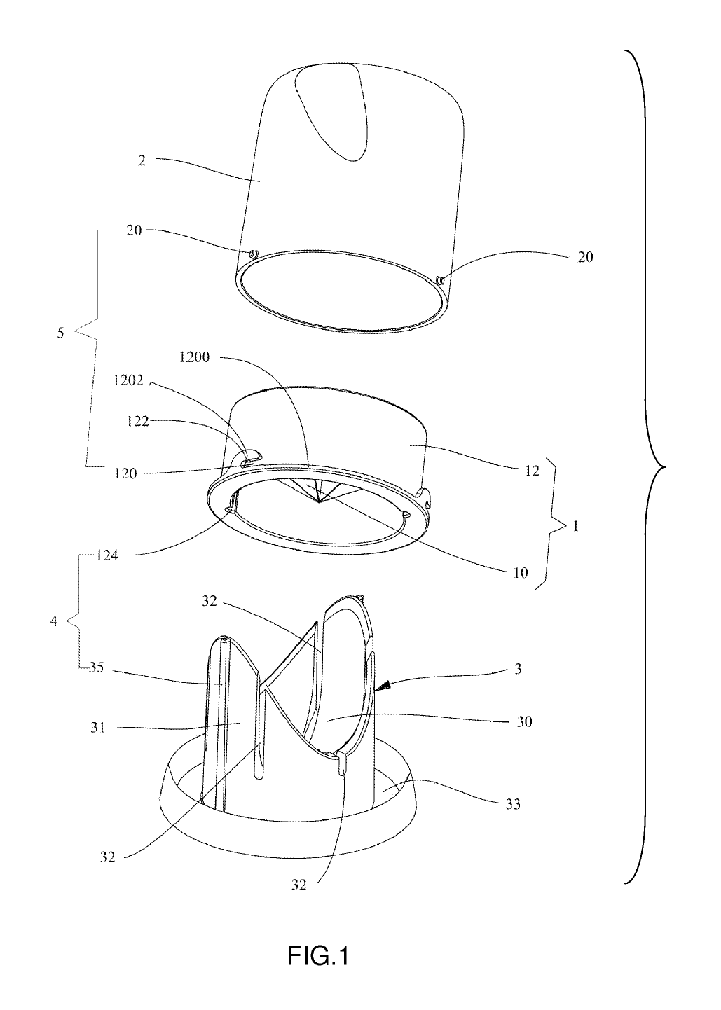

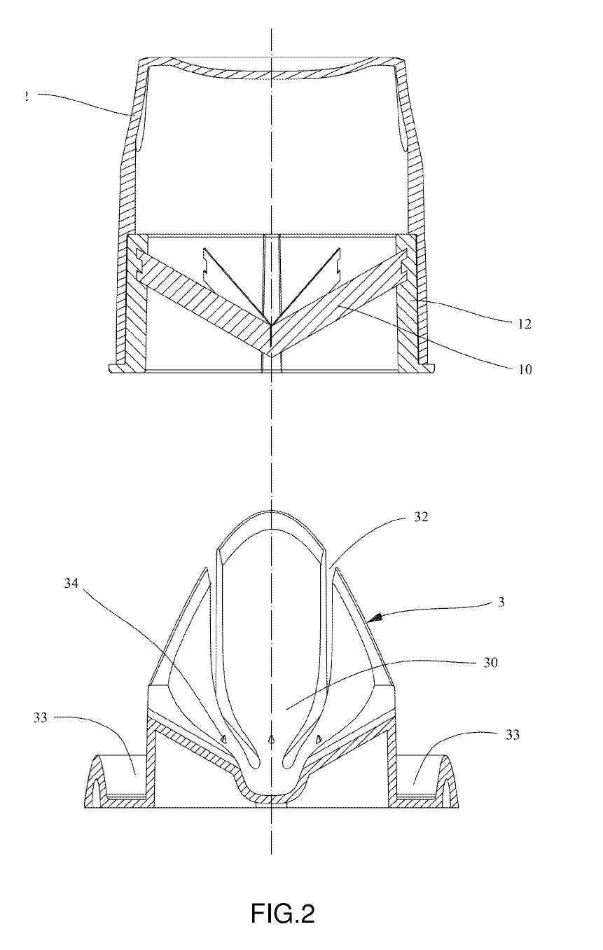

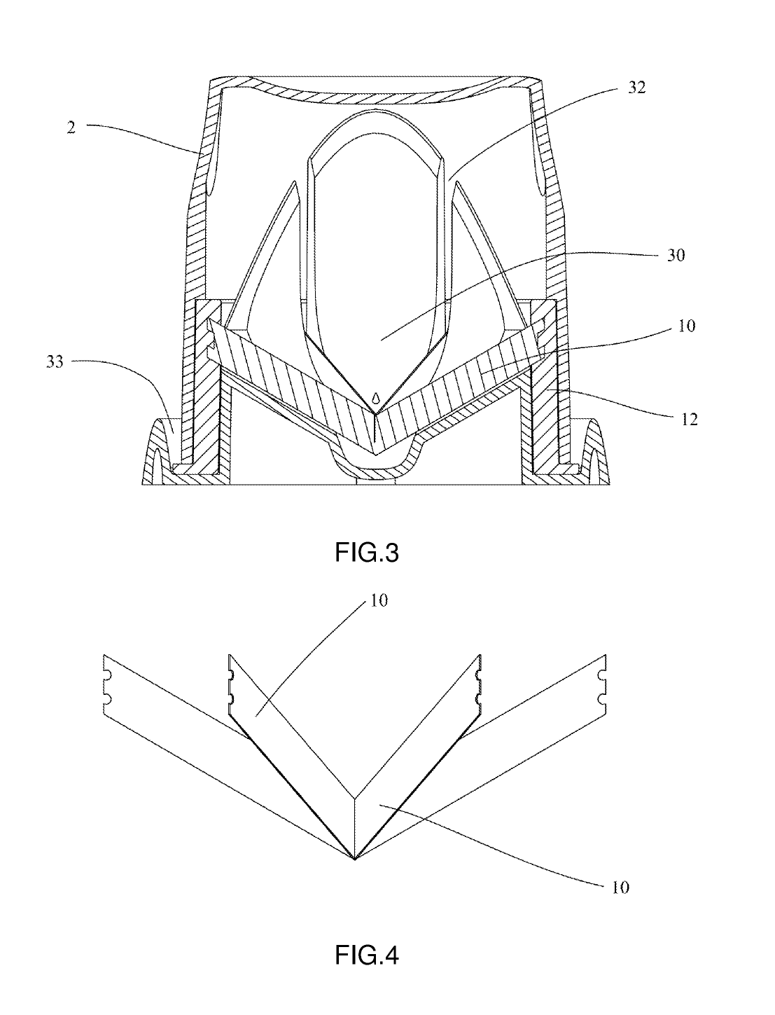

Referring to FIGS. 1 to 4, a device for cutting fruit, vegetables or the like according to the embodiment of the present invention includes a cutting member 1, a cap 2, and a base 3. The cutting member 1 includes a cylindrical casing 12 combining blades 10 therein. The cap 2 can be releasably fitted on the cutting member 1, and is adapted to operate with one hand in cutting operation. The base 3 is configured to retain materials to be cut therein, and support the cutting member 1 thereon during cutting fruit or when the cutting member 1 rests thereon.

An annular flange 1200 coaxially extends outwards from the bottom edge of the cylindrical casing 12, and one or more than one clamps 1202 longitudinally project upwards from the annular flange 1200, therefore, an aperture 120 is defined between each clamp 1202 and the annular flange 1200. The clamp 1202 has a shape in an exemplary embodiment like a horizontal or slantwise letter “L”. Preferably, there are two or more clamping means 1202 with apertures 120 symmetrically disposed on outer surface of the cylindrical casing 12. The cylindrical casing 12 defines at least one, preferably two or more guiding grooves 124 in the inner surface thereof. There are sets of cutting members 1 provided to the cutting device of the present invention for cutting different material or different cutting needs. Herein, each set of cutting member has different numbers, size or even shape of blades, such as four pieces of blades (as shown in FIG. 4), Six or eight pieces of blades. The user can choose the desired cutting member to assemble it into the cap 2 for cutting work.

The blades 10 are substantially coaxially fixed in the cylindrical casing 12, and one end of each blade converges to a point at the central axis of the cylindrical casing 12. From the point, blades 10 with the other ends extend radially upwards to the perimeter of the cylindrical casing 12, namely, at an angle relative to the horizontal. Preferably, the radial blades 10 have the other ends fixed in the inner wall of the cylindrical casing 12. Therefore, the converged ends of the blades are lower than the ends embedded in the inner wall of the casing 12.

In an embodiment as shown in FIG. 1, the cap 2 is generally in the form of an open ended cylinder, and preferably comprised of transparent material in order to monitoring fruit or the like during cutting operation. Corresponding to the apertures 120 and clamps 1202 on the outer surface of cylindrical casing 12, short sticks 20 are set on the outer surface of the cylindrical cap 2. When the cap 2 is assembled onto the cutting member 1, bottom edge at the open end of the cap 2 abuts against the annular flange 1200 of the casing 12. The cap 2 further moves along the flange 1200 until the sticks 20 slide into the apertures 120, as a result, the sticks 20 are retained at the end of the aperture 120. For stop the movement of the stick 20 in the aperture 120, raised points 122 are set on the surface around the aperture, which can prevent the stick 20 slipping out from the aperture 120. But if inversely turning the cap 2 by a certain force, the sticks 20 will cross the raised points 122 and leave the apertures, and thus the cap 2 depart from the cutting member 1. Herein, the user can replace or clean the cutting member 1 if it is necessary.

The base 3 includes a vertical main body 31 and a circular bottom container 33. The vertical main body 31 has an upper concave surface 30, on which a piece of fruit or vegetables is placed. This upper surface substantially depressed downwardly, acts as a cutting board, and firmly holds a fruit or vegetables in position and permits steady cutting thereof with. The vertical main body 31 in an exemplary embodiment as shown in FIG. 1, is substantially like a cylinder with a round or elliptic cross-section. A plurality of longitudinal slots 32 are defined through the vertical main body 31, which correspond to the blades 10 of the cutting member 1 and into which the blades 10 dip when the cutting member 1 is resting on the base 3.

The base 3 has a plurality of projections 34 thereon for engaging the fruit member to prevent slippage thereof while contained in the base. Preferably, the projections 34 have a shape as tip tooth, and are set on the upper concave surface 30.

A guiding means 4 is set for guiding the cutting member 1 assembled onto the base 3 in a manner of linear movement. The guiding means includes all known structures, such as guiding edge or plate or post engaged with guiding groove, guiding wall or tube, or the like. As embodied in FIG. 1, the guiding means 4 includes guiding grooves 124 longitudinally defined in the inner surface of the cylindrical casing 12 and leading ledge 35 longitudinally set on the outer surface of base 3. Preferably, there are two or more pairs of the guiding grooves 124 and leading ledges 35 to constitute the guiding means. It is understood, the position of guiding grooves 124 and the leading ledges 35 can be interchanged each other.

The circular bottom container 33 is used for receiving juice from cutting fruit or vegetables. When assembled the device of the present invention for cuting operation or unused storage, at first, the cap 2 releasably fits onto the cutting member 1 with a connection means 5 that the sticks 20 are engaged with the clamps 1202 and releasably locked in apertures 120. Herein, the bottom edge at opened end of the cap 2 reaches the annular flange 1200, and the cylindrical casing 12 of the cutting member 1 abuts against inner wall of the cap 2. Then the cutting member 1 with the cap 2 both covers on the base 3 by the guiding means 4 as described above. Finally, the annular flange 1200 of the cutting member 1 is fitted in the circular bottom container 33 of the base 3.

At the cutting operation, the material to be cut, such as fruit, vegetables, bread, meat, or the like, is placed on the concave surface 30 of the base 3. The cap 2 is assembled onto the desired cutting member 1 in such a locked position that the sticks 20 are correspondingly locked in the apertures 120. Then, grasp the cap 2 with one hand, assure that the leading ledges 35 rightly align to guiding grooves 124, and then, press downwardly the cap 2 to the base 1. Herein, the cutting member 1 moves to the base 3 in such a linear manner that ledges 35 slide in the corresponding grooves 124, while the blades 10 cut through the fruit member, and plunge into corresponding slots 32, thus the fruit member is cut into segments or pieces. Finally, inversely turn the cap 2 and release the sticks 20 out away from apertures 120, and then the cap 2 is moved away from cutting member 1. The divided fruit member is ready for taking now.

The casing 12 and the cap 2 can be made from transparent material, such that cutting operation can be monitored.

It is understood that the cap 2 is releasably retained on the cutting member 1 via a connection means 5. The connection means is embodied as a clamp means 5 shown in FIGS. 1 to 4, which comprises sticks 20 coupling with apertures 120 defined by clamps 1202, the position of the sticks 20 and apertures 120 can be interchanged with each other. Alternatively, however, it is possible to use a bayonet mount, a screw closure or a detent connection as the connection means. All means assure fast, simple release of the cap 2 from the cutting member 1 and its fastening to it.

While the invention has been described in conjunction with specific embodiments, it is evident that numerous alternatives, modifications, and variations will be apparent to those skilled in the art in light of the forgoing descriptions. The scope of this invention is defined only by the following claims.

What is claimed is:

1. A device for cutting fruit, vegetables or the like comprising:
at least one cutting member having a casing combining blades therein;
a cap; and
a base for supporting the cutting member thereon;
wherein said cap can releasably fit on the cutting member via a connection means, and is adapted for one-hand cutting operation; said base has an upper concave surface for retaining fruit, vegetables, or the like therein.

2. The device according to claim 1, wherein said connection means between said cap and the cutting member comprises a clamping means, a screw closure, a detent connection, or bayonet mount.

3. The device according to claim 2, wherein said clamping means comprises at least one stick set on the cap, and at least one aperture correspondingly defined in the cutting member; or otherwise, at least one stick set on the cutting member, and at least one aperture correspondingly defined in the cap; and the stick can be releasably locked in the aperture.

4. The device according to claim 3, wherein said casing of the cutting member is substantially cylindrical with a bottom open end, and coaxially forms an annular flange at bottom edge thereof; at least one clamp longitudinally extends upward or downward from the annular flange and defines said aperture therebetween; raised points are set on surface around the aperture so as to prevent the stick slipping out from the aperture.

5. The device according to claim 1, wherein each blade with one end thereof joining at a point on a central axis in the casing, and with the other end thereof radially extending from the point to inner wall of the casing; and the other ends of blades are embedded in the inner wall of the casing.

6. The device according to claim 1, wherein said base has a circular bottom container for receiving juice from cutting fruit, vegetables or the like.

7. The device according to claim 1, wherein said base defines a plurality of slots which correspond to the blades of the cutting member and into which the blades dip when the cutting member is resting on the base.

8. The device according to claim 7, wherein said base substantially has a vertical main body with said upper concave surface on top thereof, and the plurality slots are longitudinally defined from said upper concave surface downwardly through the vertical main body to a certain depth.

9. The device according to claim 8, wherein said main body is substantially configured like a vertical cylinder having a round or elliptical cross-section.

10. The device according to claim 1, wherein the base has a plurality of projections thereon for engaging the fruit, vegetables or the like member to prevent slippage thereof while contained in the base.

11. The device according to claim 1, wherein said cutting member can move to rest on the base via a guiding means by which the cutting member linearly moves on the casing.

12. The device according to claim 11, wherein said guiding means comprises at least one pair of leading ledge or post and corresponding guiding groove or wall engaged with each other; therein, both the leading ledge or post, and the corresponding guiding groove or wall, is defined either in inner surface of the casing of the cutting member or on outer surface of the base.

13. The device according to claim 1, wherein applied for the device, there is a plurality of cutting members with different numbers or shapes of blades.

14. A device for cutting fruit, vegetables or the like comprising:
a cutting member for cutting fruit, vegetables or the like; and
a base for supporting the cutting member thereon;
wherein said cutting member has a casing and a plurality of blades fixed therein;
said base has a vertical main body with an upper concave surface on top thereof for holding fruit, vegetables, or the like inside.

15. The device according to claim 14, wherein said base has a circular bottom container for receiving juice from cutting fruit, vegetables or the like; the casing of cutting member has an annular flange at opened end thereof; when the cutting member is resting on the base, the annular flange is fitted in the circular container.

16. The device according to claim 14, wherein said base defines a plurality of slots which correspond to the blades of the cutting member and into which the blades dip when the cutting member is resting on the base; and the plurality slots are longitudinally defined from said upper concave surface downwardly through the vertical main body to a certain depth.

17. The device according to claim 14, wherein said cutting member can move to rest on the base via a guiding means by which the cutting member linearly moves on the casing.

18. The device according to claim 11, wherein said guiding means comprises at least one leading ledge, post, or the like set on outer surface of the base, and at least one guiding groove or wall correspondingly defined in inner surface of the casing of the cutting member; or otherwise, said guiding means comprises at least one leading ledge or post or the like defined in inner surface of the casing, and at least one guiding groove or wall correspondingly set on outer surface of the base; the leading ledge or post can linearly slide along the guiding groove or wall.

19. A base of a device for cutting fruit, vegetables or the like comprising:
a main body; and
a circular container at bottom of the main body for receiving juice from cutting fruit, vegetables or the like;
wherein the main body has a upper concave surface for retaining fruit, vegetables, or the like therein; and is adapted to support cutting member thereon.

20. The base according to claim 19, wherein said main body defines a plurality of slots from said upper concave surface downwardly to a certain depth therein for receiving cutting blades; and a plurality of projections is set in the base for engaging the fruit, vegetables or the like member to prevent slippage thereof while contained in the base.
